(19) United States
(12) Patent Application Publication
(10) Pub. No.: US 2017/0203616 A1
(43) Pub. Date: Jul. 20, 2017

(54) PUNCTURE-PROOF STRUCTURE FOR TIRES

(71) Applicant: SHUT CHEN HSU, YILAN COUNTY 260 (TW)

(72) Inventor: SHUT CHEN HSU, YILAN COUNTY 260 (TW)

(21) Appl. No.: 14/995,352

(22) Filed: Jan. 14, 2016

(51) Int. Cl. B60C 17/04

(52) U.S. Cl. CPC B60C 17/047

(57) ABSTRACT

A puncture-proof structure for tires provides a spare tire body that can be installed to a tire rapidly and is applicable to various tire types by using fine tuning. The tire has its two top inner edges formed with circular hooked portions for engaging with the spare tire body made of serially connected combining blocks. When the tire gets punctured and damaged by a knife or a sharp article, the spare tire body allows the tire to keep work safely. Therein, the spare tire body is a C-shaped member composed of two C-shaped holding pieces. It can be engaged with the hooked portions of the tire rapidly and arm the tire with puncture-proof ability.

### BACKGROUND OF THE INVENTION

1. Technical Field

The present invention relates to a puncture-proof structure for tires, which can be rapidly installed into a tire and is adaptive to various tire types by using fine tuning, thereby ensuring driving safety.

2. Description of Related Art

Generally, tires can be categorized into regular tires that have an inner tube therein and tubeless tires without using an inner tube, both of which are not resistant to damages caused by external force. A tire with an inner tube is ready to work when the inner tube is inflated to expand an outer tube of the tire. Upon puncture by a knife or a sharp article, the tire becomes flat and unusable immediately, bringing the driver with much trouble, such as shoving the car. In the case such a tire gets punctured when the car using it is running fast, traffic accidents are likely to happen. On the other hand, tubeless tires are known to be able to defer the tire's complete flatness upon puncture, so as to provide sufficient buffer time for the driver to drive the car to a nearby repair workshop. While this buffering function does allow a driver with a damaged tubeless tire to safely arrive at a repair workshop, this function can also hinder a car driver from immediately noticing the tire damage as the tire pressure does not drop sharply. In this case, if the car driver is not aware of the tire damage drives his/her car in high speed or on a rugged road, the tire is likely to become unusable immediately and put the driver into the risk of a traffic accident that endangers his/her life.

In view of the shortcomings of the prior-art devices, the present inventor is concerned about the public traffic safety and has invented numerous novel tire improvements, including many that have been patented in many countries. Nevertheless, instead of being complacent about his achievements, the inventor continues to research and improve his patented inventions and herein provides a further improved simplified structure that can be assembled rapidly in order to benefit the public in terms of driving safety.

### SUMMARY OF THE INVENTION

The present invention is directed to a puncture-proof structure for tires. Particularly, the puncture-proof structure provides a spare tire body that can be installed to a tire rapidly and is applicable to various tire types by using fine tuning. The tire has its two top inner edges formed with circular hooked portions for engaging with the spare tire body made of serially connected combining blocks. When the tire gets punctured and damaged by a knife or a sharp article, the spare tire body allows the tire to keep work safely. Therein, the spare tire body is a C-shaped member composed of two C-shaped holding pieces. It can be engaged with the hooked portions of the tire rapidly and arm the tire with puncture-proof ability.

The objective of the present invention is to provide such a puncture-proof structure, wherein the preassembled spare tire body is a C-shaped part that can be directly engaged with the hooked portions of the tire, thereby achieving rapid installation. Besides, a tire using the spare tire body is puncture-proof such that when punctured by sharp articles or knifes, the tire can still work to make safe arrival at a nearby repair workshop. This saves a car driver who has a flat tire from shoving the car along a high-traffic road and risking his/her life, thereby ensuring the public traffic safety.

### BRIEF DESCRIPTION OF THE SEVERAL VIEWS OF THE DRAWINGS

FIG. 1 is a cutaway view of a tire for working with the puncture-proof structure for tires of the present invention;

FIG. 2 is a perspective view of a combining block of the puncture-proof structure;

FIG. 3 is another perspective view of the combining block of the puncture-proof structure;

FIG. 4 is another perspective view of the combining block of the puncture-proof structure;

FIG. 5 is a perspective view of a linking frame of the puncture-proof structure;

FIG. 5A is another perspective view of the linking frame of the puncture-proof structure;

FIG. 6 is a perspective view of a pressing shaft of the puncture-proof structure;

FIG. 7 is a perspective view of a pressing bolt of the puncture-proof structure;

FIG. 8 is a perspective view of a linking plate of the puncture-proof structure;

FIG. 9 shows two first connectors and one second connector of the puncture-proof structure to be assembled;

FIG. 10 is a perspective view of two C-shaped holding pieces of the puncture-proof structure;

FIG. 11 is a partially exploded view of a spare tire body formed by the puncture-proof structure;

FIG. 12 is a perspective view of the spare tire body formed by the puncture-proof structure;

FIG. 13 shows components at two joined ends of the spare tire body formed by the puncture-proof structure;

FIG. 14 is a cross-sectional view of a tire having the spare tire body formed by the puncture-proof structure engaged with hooked portions of the tire;

FIG. 15 is another cross-sectional view of the tire having the spare tire body form by the puncture-proof structure engaged with the hooked portions of the tire.

### DETAILED DESCRIPTION OF THE INVENTION

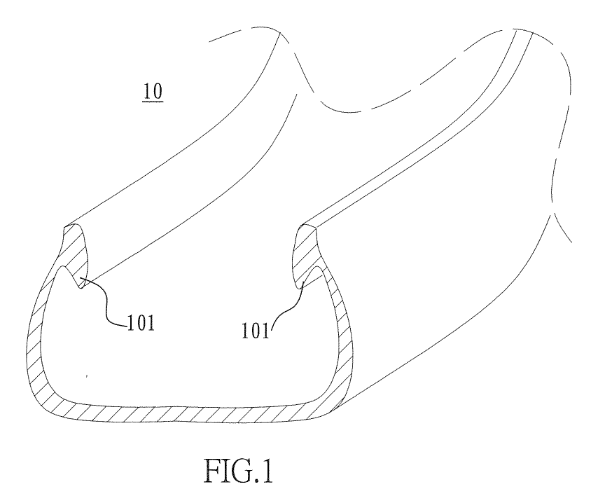

The present invention provides an improved puncture-proof structure for tires. Referring to FIG. 1, a tire 10 has its two top inner edges formed with hooked portions 101 and is reinforced by cords arranged therein.

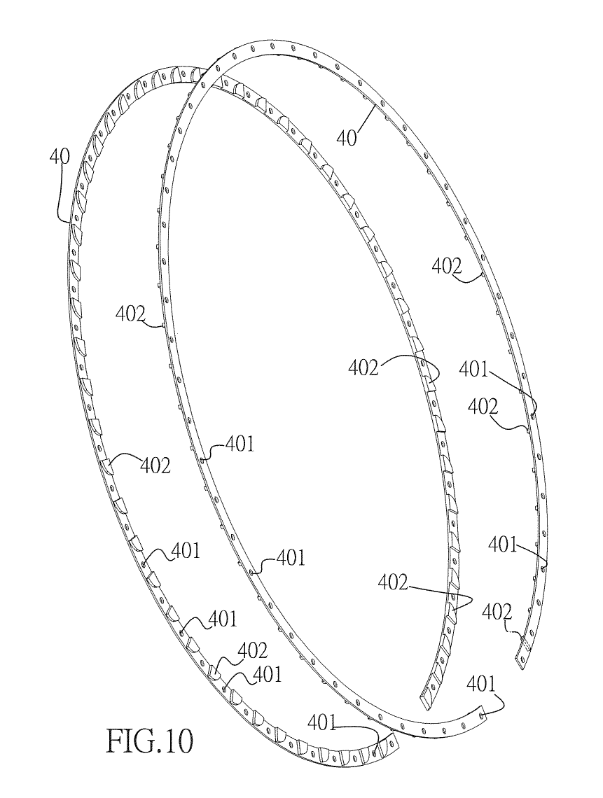

Referring to FIG. 10, two C-shaped holding pieces 40 each have a C-shaped body formed with plural spaced locking holes 401 and bumps 402 raised from its inner surface.

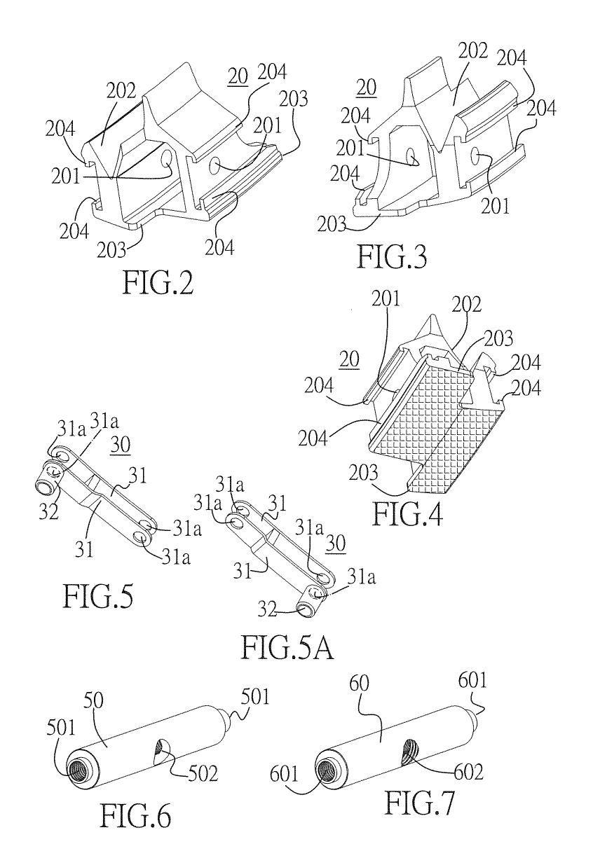

A plurality of combining blocks 20, as shown in FIGS. 2, 3 and 4, is a hollow member with two lateral sides thereof provided with through holes 201 and with its top formed as an engaging valley 202. The combining block 20 has its two lengthwise ends diagonally formed with projecting portions 203. An engaging rib 204 is formed above each of the through holes 201 at the two sides of the combining block 20. Additionally, each of the combining blocks 20 has its bottom provided with embossment.

Two linking frames 30, as shown in FIG. 5 and FIG. 5A, each of which has two linking plates 31 and a spacer arranged therebetween and is formed into an H-like body. The linking plate 31 has its two ends each provided with a pivot hole 31a. Therein, one of the linking plates 31 has its pivot hole 31a at one end thereof additionally attached by a bush 32.

Referring to FIG. 6, a pressing shaft 50 is an axle that has its two ends formed with threaded holes 501, and has a through hole 502 running radially therethrough.

A pressing bolt 60, as shown in FIG. 7, is an axle that has its two ends formed with threaded holes 601, and has a threaded retaining hole 602 running radially therethrough.

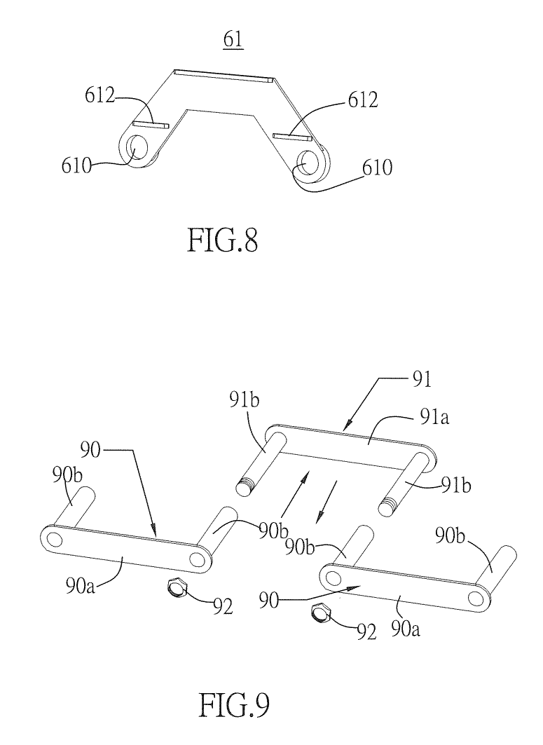

A plurality of connecting members 61, as shown in FIG. 8, each is formed like a humpback bridge with two ends thereof each having a through hole 610. A rib 612 is formed above the through hole 610.

A plurality of first connectors 90, as shown in FIG. 9, has a slat 90a and two separated bushes 90b.

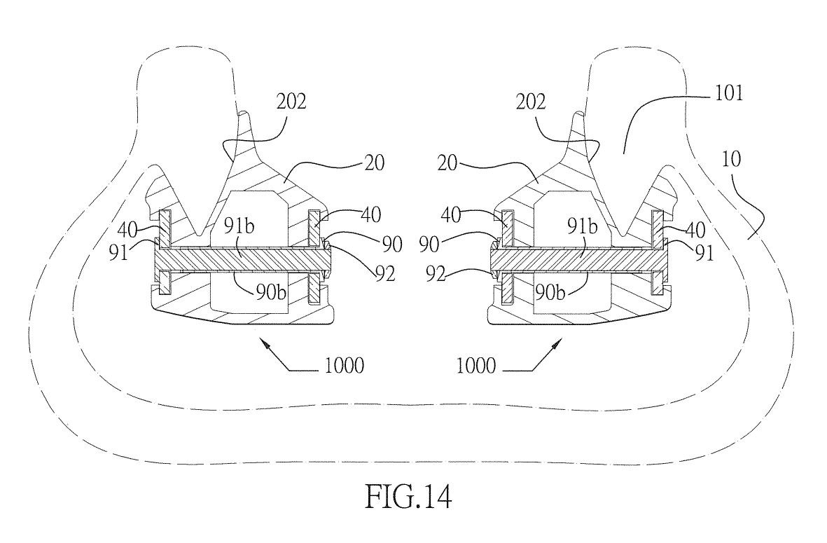

A plurality of second connector 91, has a slat 91a and two separated threaded aims 91b (also referring to FIG. 14).

When assembled, the threaded arms 91b of one second connector 91 are combined with two bushes 90b from two different first connectors 90, and then retained by two nuts 92, separately.

Also included are a screw 91c, a locking tube 94

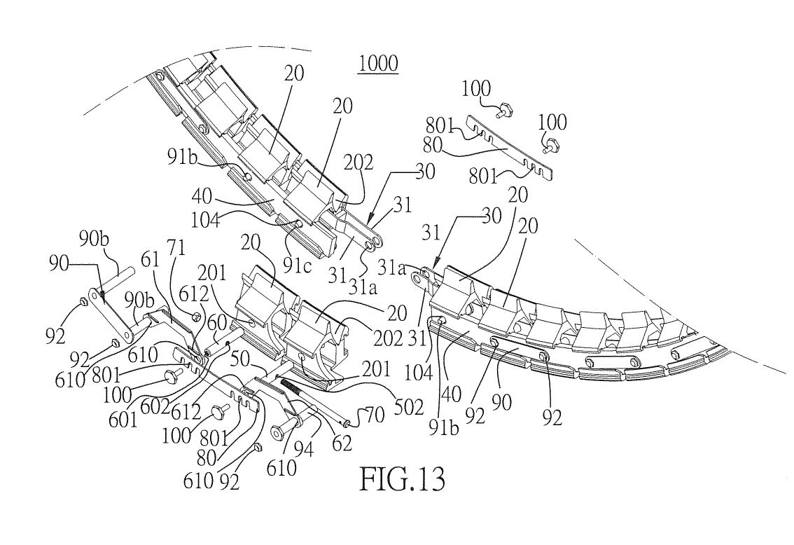

a packing screw 70 (FIG. 13),

a locknut 71 (FIG. 13), and
a plurality of adjusting members 80, as shown in FIG. 13, having a plurality of spaced notches 801 formed at one edge thereof.

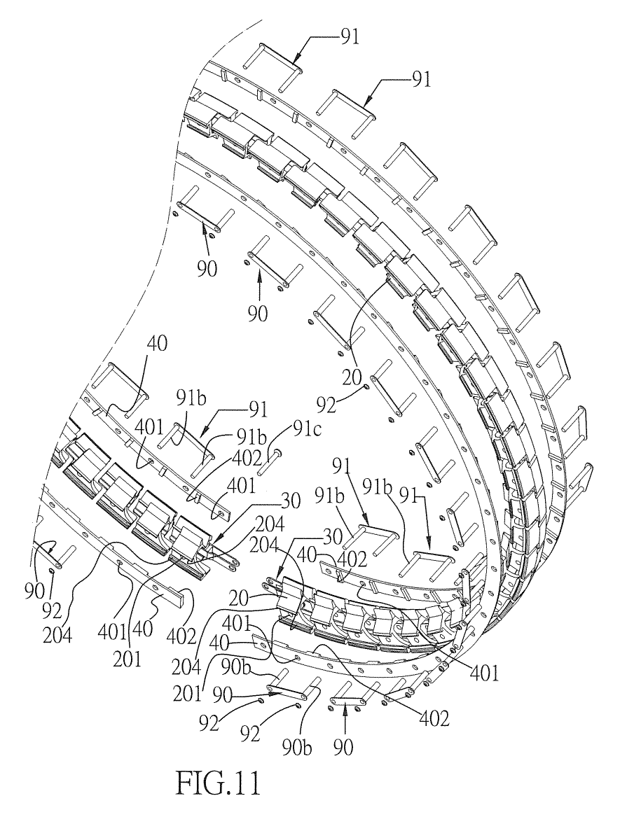

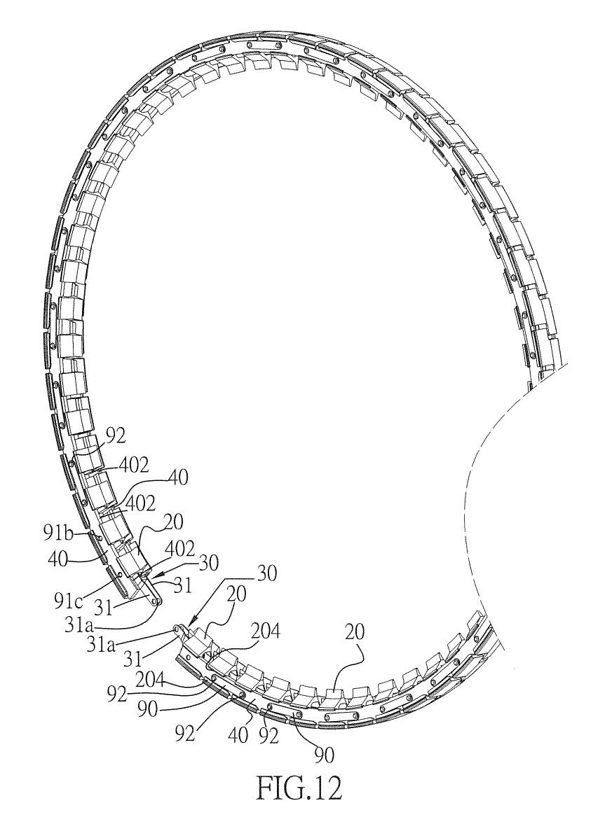

FIG. 11 is a partially exploded view of a spare tire body formed by the puncture-proof structure. As shown in FIG. 11 and FIG. 12, the two C-shaped holding pieces 40 are retained by the engaging ribs 204 at two edges of the combining blocks 20. Meanwhile, the locking holes 401 of the two C-shaped holding pieces 40 are aligned with the through holes 201 at two sides of the combining blocks 20. Then the bushes 90b of the first connector 90 (referring to FIGS. 9 and 14) and the threaded arms 91b of the second connector 91 are inserted into the locking holes 401 of the two C-shaped holding pieces 40, respectively, and enter the through holes 201 of the combining blocks 20. At this time, each bush 90b of the first connectors 90 receives one threaded arm 91b of the second connector 91, so that the combining blocks 20 are connected in series. Afterwards, the nuts 92 fix the threaded arms 91b of the second connector 91, so the components are combined into two C-shaped assemblies. Additionally, a screw 91c is inserted into the locking holes 401 of the two C-shaped assemblies and the through holes 201 of the combining blocks 20 as preliminarily positioned. Therein, the foremost and the rearmost combining blocks 20 each have a linking frame 30 attached thereto, as also shown in FIGS. 5, 5A, 11 and 12. As shown in FIG. 13, the space between the two linking plates 31 at one end of the linking frame 30 allows one later wall of one combining block 20 to be received therein, so that when the linking frame 30 and the combining block 20 are assembled, the pivot hole 31a and the bush 32 of the linking plate 31 are aligned with the through hole 201 of the combining blocks 20. The screw 91c and one threaded arm 91b of the second connector 91 are respectively inserted into the locking holes 401 of the C-shaped holding piece 40, the pivot holes 31a of the linking frame 30, the through holes 201 of the combining block 20, the bushes 32 of the linking frame 30, and the through holes 201 of the combining blocks 20, and are exposed outside the locking holes 401 of the C-shaped holding piece 40 as preliminarily positioned. The space between the two linking plates 31 at the opposite end of the linking frame 30 allows one later wall of another combining block 20 to be received therein. At this time, the pivot holes 31a of the two linking plate 31 are aligned with the through holes 201 of the combining block 20. Then a pressing shaft 50 and a pressing bolt 60 are inserted into the through holes 201 of the two combining blocks 20, respectively, as also shown in FIGS. 5 and 5A. Two screws 100 are inserted into two through holes 610 from two different connecting members 61 and screwed into the threaded holes 501, 601 of the pressing shaft 50 and the pressing bolt 60, respectively. Meanwhile, two additional screws 100 are screwed into threaded holes 501, 601 at the opposite end of the pressing shaft 50 and the pressing bolt 60. Then a bush 90b of a first connector 90 is inserted into the other through hole 610 of a connecting members 61. Thus, the two bushes 90b of the first connector 90 receive the threaded aim 91b of the second connector 91 and the screw 91c. Then nuts 92 are screwed to the threaded arm 91b and the screw 91c for fixing. The locking tube 94 is inserted into the other through hole 610 of another connecting members 61 and receives the threaded arm 91b of the second connectors 91. Then a nut 92 is screwed to the threaded arm 91b for fixing, so as to form the C-shaped spare-tire body 1000.

Therein, the two C-shaped holding pieces 40 have the bumps 402 at their inner surface inlaid between the combining blocks 20, thereby further ensuring the overall stability of the spare-tire body 1000.

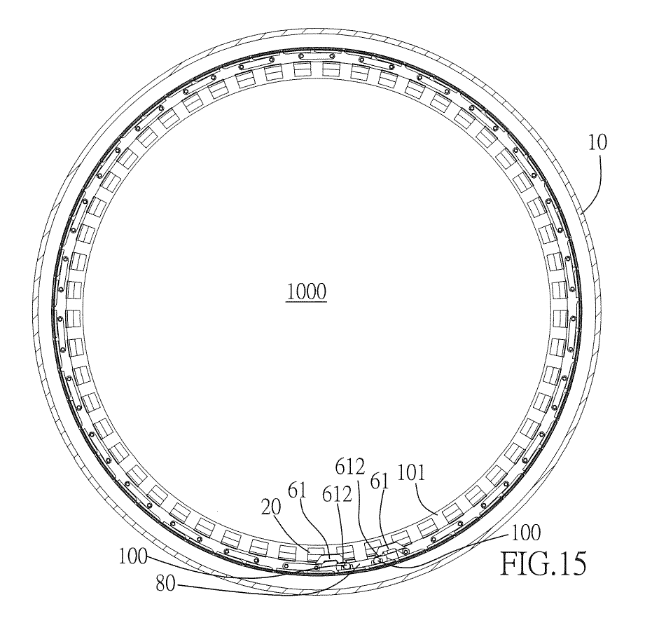

As shown in FIGS. 12, 13, 14 and 15, the engaging valleys 202 of the combining blocks 20 of the spare-tire body 1000 are combined with the hooked portions 101 of the tire 10. A packing screw 70 is inserted into the through hole 502 of the pressing shaft 50 and screwed into the threaded hole 601 of the pressing bolt 60 at the combining blocks 20 at the front and rear ends of the spare-tire body 1000, so as to retain the spare-tire body 1000 along the hooked portions 101 of the tire 10. Afterward, a locknut 71 is screwed to the packing screw 70 for preventing the packing screw 70 from unscrewing. Then the four screws 100 screwed to the spare-tire body 1000 at the threaded holes 501, 601 of the pressing shaft 50 and the pressing bolt 60 are slightly unscrewed to allow the notches 801 of the adjusting members 80 to fit on the screws 100. Afterward, the screws 100 are screwed tight. Therein, the ribs 612 of the connecting members 61 press against the upper edges of the adjusting members 80 so as to firmly secure the adjusting members 80 from escape, thereby provide the tire with puncture-proof capability.

To sum up, the present invention is effective in preventing puncture and ensuring driving safety with simple configuration that requires significantly reduced manufacturing costs and time and can be assembled easily.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A puncture-proof structure for tires, comprising:
a tire, having two top inner edges thereof formed with hooked portions and being reinforced by cords arranged therein;
two C-shaped holding pieces having locking holes that are spaced from each other and having bumps that are spaced form each other and raised from an inner surface thereof;
a plurality of combining blocks, each being a hollow member that has two lateral sides thereof provided with through holes and has a top formed as an engaging valley, the combining block having two lengthwise ends thereof diagonally formed with projecting portions and having engaging ribs each formed above one said through hole, and having embossment formed at a bottom thereof;
two linking frame, each having two linking plates and a spacer arranged therebetween, the linking plate having two ends thereof each provided with a pivot hole, wherein one of the linking plates has the pivot hole at one end thereof additionally provided with a bush;
a pressing shaft, being an axle that has two ends thereof formed with threaded holes, and has a through hole running radially therethrough;
an axle that has two ends thereof formed with threaded holes and has a threaded retaining hole running radially therethrough;
a plurality of connecting members , each being formed like a humpback bridge with two ends thereof each having a through hole above which a rib is formed;
a plurality of first connector, having a slat and two separated bushes;
a plurality of second connector, having a slat and two separated threaded arms;
whereby when assembled, the threaded arms of one said second connector are combined with two said bushes from two different said first connectors, and then retained by two nuts, separately;
a screw;
a locking tube;
a packing screw;
a locknut; and
a plurality of adjusting member, each having a plurality of spaced notches formed at one edge thereof;
the two C-shaped holding pieces being retained by the engaging ribs of the combining blocks, the locking holes of the two C-shaped holding pieces being aligned with the through holes of the combining blocks, then the bushes of the first connector and the threaded arms of the second connector being inserted into the locking holes of the two C-shaped holding pieces, respectively, and entering the through holes of the combining blocks, each said bush of the first connectors receives one said threaded arm of the second connectors, so that the combining blocks are connected in series, the nuts fixing the threaded arms of the second connectors, thereby forming C-shaped assemblies, the foremost and the rearmost combining blocks each having a linking frame attached thereto, a space between the two said linking plates at one end of the linking frame receiving one of the two later sides of one said combining block with the pivot hole and the bush of the linking plate aligned with the through hole of the combining block, the screw and one said threaded arm of the second connector being respectively inserted into the locking holes of the C-shaped holding piece, the pivot hole of the linking frame, the through holes of the combining block, the bush of the linking frame, and the through holes of the combining blocks, and exposed outside the locking holes of the C-shaped holding piece as preliminarily positioned, a space between the two linking plates at an opposite end of the linking frame receiving one of the two later walls of another said combining block, the pivot holes of the two linking plate being aligned with the through holes of the combining blocks, then a pressing shaft and a pressing bolt being inserted into the through holes of the two combining blocks, respectively, two screws being are inserted into two said through holes from two different said connecting members and screwed into the threaded holes of the pressing shaft and the pressing bolt, respectively, two additional screws being screwed into threaded holes at an opposite end of the pressing shaft and the pressing bolt, then one said bush of one said first connector being inserted into the other through hole of one said connecting members, the two bushes of the first connector receiving the threaded arm of the second connector and the screw, then the nuts being screwed to the threaded arm and the screw for fixing, the locking tube being inserted into the other through hole of another said connecting members and receiving the threaded arm of the second connectors, then the nut being screwed to the threaded arm for fixing, so as to form a C-shaped spare-tire body;
the two C-shaped holding pieces having the bumps at their inner surface inlaid between the combining blocks, thereby further ensuring the overall stability of the spare-tire body;
the engaging valleys of the combining blocks of the spare-tire body being combined with the hooked portions of the tire, the packing screw being inserted into the through hole of the pressing shaft and screwed into the threaded hole of the pressing bolt at the combining blocks at the front and rear ends of the spare-tire body, so as to retain the spare-tire body along the hooked portions of the tire, then the locknut being screwed to the packing screw for preventing the packing screw from unscrewing, afterward the four screws screwed to the spare-tire body at the threaded holes of the pressing shaft and the pressing bolt being slightly unscrewed to allow the notches of the adjusting members 80 to fit on the screws, and at last the screws being screwed tight, wherein, the ribs of the connecting members press against upper edges of the adjusting members so as to firmly secure the adjusting members from escape, thereby provide the tire with puncture-proof capability.
